(19) United States
(12) Patent Application Publication
(10) Pub. No.: US 2013/0322654 A1
(43) Pub. Date: Dec. 5, 2013

(54) AUDIO SIGNAL PROCESSING DEVICE AND PROGRAM

(71) Applicant: Yamaha Corporation, Hamamatsu-shi (JP)

(72) Inventor: Masaaki OKABAYASHI, Hamamatsu-shi (JP)

(73) Assignee: YAMAHA CORPORATION, Hamamatsu-shi (JP)

(21) Appl. No.: 13/900,233

(22) Filed: May 22, 2013

(30) Foreign Application Priority Data
May 24, 2012 (JP) 2012-118177

(51) Int. Cl. H04R 3/00

(52) U.S. Cl. CPC H04R 3/00
USPC 381/119

(57) ABSTRACT

A PC (DAW) records audio signals of input channels outputted from a mixer. When the PC (DAW) newly creates a project for recording, the PC (DAW) obtains channel configuration information from the mixer, creates the same number of tracks as the number of the channels indicated in the channel configuration information, and gives the each track the same name as the corresponding channel indicated in the channel configuration information. It is thereby enabled to easily perform setting at a time of recording.

### TECHNICAL FIELD

The invention relates to an audio signal processing device (DAW) capable of recording audio signals outputted from a mixer.

### BACKGROUND ART

Conventionally, at sites of a PA (Public Addressing) being a broadcast facility transmitting audio information to a number of people for such as a broadcast in facilities and in schools, and an SR (Sound Reinforcement) being a broadcast facility transmitting performance sounds, vocal sounds, and so on in every corner of even a large-scale hall such as a concert hall in a uniform sound quality, performance sounds of instruments and vocal sounds are picked up by a microphone, and a mixer is used to perform mixing and sending out the mixed audio signal to a power amplifier and various kinds of recording equipment and to an effector and a performing player. A conventional mixer includes: an I/O unit having an input port to which audio signals picked up by the microphone and audio signals from digital recording equipment such as a synthesizer are inputted, and an output port outputting digital and analog audio signals; an audio signal processing unit performing mixing and addition of effect on digital audio signals; and a console for adjusting performance into a state most suitably expressing the performance by operating various kinds of panel operation elements. An amplifier is connected to the output port from which the analog audio signals of the mixer are outputted, plural speakers provided in a hall and so on are connected to the amplifier, and the audio signals amplified by the amplifier are emitted from the speakers.

In the conventional PA/SR sites, the audio signals of respective channels outputted from the mixer are recorded to separate tracks by using an MTR (Multi Track Recorder). It is thereby possible to adjust each of volumes and pans of respective instrumental sounds such as a drum, base, guitar, piano and the like, and vocal recorded separately at a music creation time, to add effects on the vocal, and to add different effects on the respective instruments. By utilizing the functions, sound quality of each audio signal can be finely adjusted in music creation.

Incidentally, in is known to perform audio processing works such as recording, edition, and mixing on data of performance by digital signal processing in an audio signal processing device using a general-purpose computer. Such audio signal processing device is realized by installing an application program called as a “DAW software” into the computer, and it is called as a Digital Audio Workstation (DAW). The DAW comes to be used at sites of PA/SR for recording audio signals of each channel of a mixer instead of MTR because real time recording becomes possible owing to a progress in functions of DAW, and a computer where the DAW is operating is superior in portability.

Note that it is often the case that the PA/SR system and a recording system are independently designed and operated, and therefore, settings of channel configuration information, track configuration information or the like, and operations thereof are separately performed in each of the systems. In this case, it is known that track configuration information is stored as a template in a conventional DAW, and a new project is started from a template incorporated in a program beforehand, thereby enabling to save time for setting track configuration from the first stage in each project (refer to NPL1).

Besides, it is possible to set channel configuration information, track configuration information or the like in advance in both a mixer and a DAW, and they will work by connecting necessary cables, and logically connecting the mixer and the DAW software at setting time at a site. However, when there is a modification in number of channels or so on at setting time at a site, it is necessary to change the settings at both the mixer side and the DAW side.

Besides, in the conventional DAW, the following configuration is considered. That is, the DAW detects audio device connected via a communication network when the DAW reads a project file including a track data, specific information of an external device set to be used, and parameters of the external device. Then the DAW associates the detected external device with the external device set to be used at the time of storing the project file. Further, the DAW synchronizes parameters between the detected external device and parameter memory of the DAW by transferring parameters stored in the parameter memory to the external device for which the association is completed. According to the configuration, parameters of the external device and those in the parameter memory can be synchronized, and thereby enabling restoration of musical functions at the time of storing the project file regarding the audio devices for which the association is completed (refer to PTL1).

### CITATION LIST

### Non Patent Literature

{NPL1} Steinberg Media Technologies GmbH, “CUBASE LE5 Operation Manual”, pp. 9-12, [online], [retrieved on Nov. 3, 2011], Internet <http://www.zoom.co.jp/archive/Japanese_Manual/CubaseLE5_Operation_Manual_jp.pdf>

### Patent Literature

{PTL1} JP 2007-293312 A

### SUMMARY OF INVENTION

### Technical Problem

When audio signals of respective channels of a mixer are recorded by using a DAW, various kinds of signals are inputted to the DAW to be recorded, such as an audio signal different from an input to the mixer, a direct out of an input channel of the mixer, and an output from an arbitrary point of the input channel of the mixer. Further, settings are performed separately at the mixer side and the DAW side, and therefore, it takes time for setting at a time of recording, and similarly it also takes time when a sudden modification of the setting is required. As stated above, there is a problem in which it takes a lot of time to set up the DAW while maintaining matching between the mixer and the DAW at the time of recording.

Accordingly, an object of the invention is to provide an audio signal processing device (DAW) which can be easily set up at a time of recording.

### Solution to Problem

To attain the above object, an audio signal processing device of the invention is configured as an audio signal processing device having recording function to record audio signals of one or more channels outputted from a mixer, wherein the audio signal processing device obtains channel configuration information from the mixer, reflects the obtained channel configuration information to track configuration information in a project newly created at a time of recording, and records the audio signals of the respective channels in same number of tracks as the channels, respectively, the tracks being created based on the track configuration information to which the channel configuration information is reflected

It is also conceivable that the audio signal processing device reflects information of number of channels and names of the channels included in the channel configuration information to number of tracks and name of the tracks in the track configuration information, respectively, and the audio signal processing device creates the same number of the tracks as the channels and gives each of the created tracks the same name as each of the channels, based on the track configuration information.

The invention can be realized also as method, system, machine-readable medium, or any other configuration.

The above and other objects, features and advantages of the invention will be apparent from the following detailed description which is to be read in conjunction with the accompanying drawings.

### Advantageous Effects of Invention

According to the invention, channel configuration information is obtained from a mixer, and the obtained channel configuration information is reflected on track configuration information of a new project created at a time of recording, and therefore, settings at a time of recording audio signals of channels outputted from the mixer at an audio signal processing device can be easily performed. Note that it is preferable that information of number of channels and channel names included in the channel configuration information is reflected on at least information of number of tracks and track names of the track configuration information.

### BRIEF DESCRIPTION OF DRAWINGS

FIG. 1 is a block diagram illustrating a configuration of an audio signal processing system using an audio signal processing device which is an embodiment of the invention.

FIG. 2 is a view illustrating a configuration of another audio signal processing system in which the audio signal processing device of an embodiment of the invention is connected to an audio network.

FIG. 3 is a block diagram illustrating a hardware configuration of a mixer making up the audio signal processing system.

FIG. 4 is a functional block diagram equivalently illustrating an algorithm of mixing process in the mixer making up the audio signal processing system using the audio signal processing device of the embodiment of the invention.

FIG. 5A is a circuit block diagram illustrating a configuration of an input channel in the mixer making up the audio signal processing system using the audio signal processing device of the embodiment of the present invention.

FIG. 5B is a circuit block diagram illustrating a configuration of an output channel in the same mixer.

FIG. 6 is a flowchart of a connecting process executed by the audio signal processing device of the embodiment of the present invention.

FIG. 7 is a view illustrating a memory image of channel configuration information of the mixer using the audio signal processing device of the embodiment of the invention.

FIG. 8 is a view illustrating a memory image of the channel configuration information of the audio signal processing device of the example of the invention.

### DESCRIPTION OF EMBODIMENTS

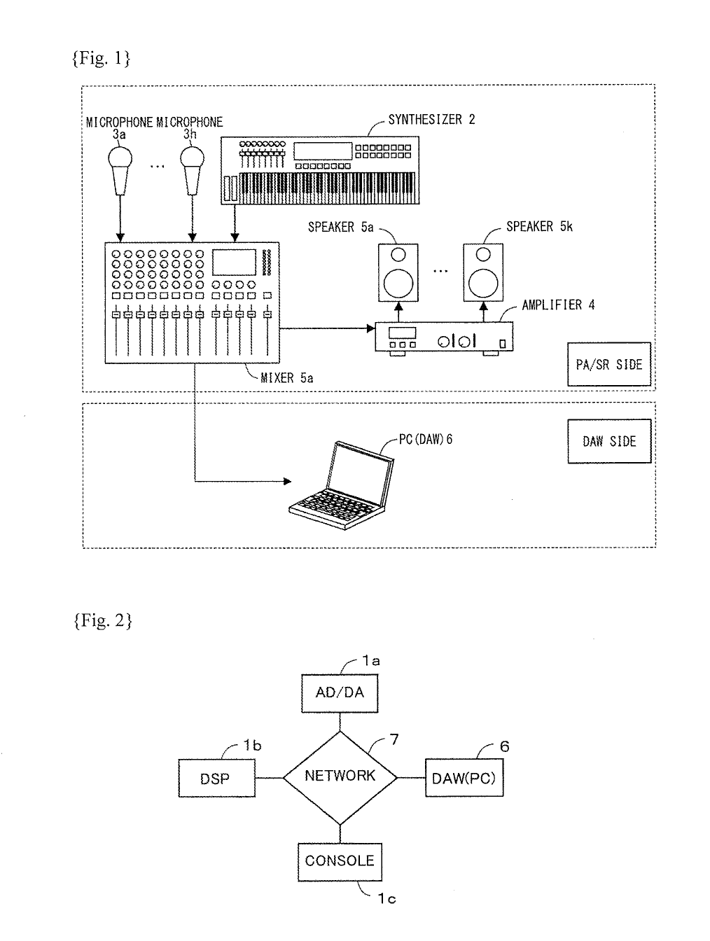

A block diagram illustrating a configuration of an audio signal processing system using an audio signal processing device of an embodiment of the invention is illustrated in FIG. 1.

The audio signal processing system illustrated in FIG. 1 includes a PA/SR system and a recording system connected to the PA/SR system. The PA/SR system includes a mixer 1 to which analog audio signals from plural number of microphones 3a, . . . , 3h provided at a hall and so on and digital audio signals from a synthesizer 2 are inputted, an amplifier 4 amplifying audio signals outputted from the mixer 1 after being mixed, and plural speakers 5a, . . . , 5k emitting tone of amplified audio signals outputted from the amplifier 4. Besides, DAW software is installed into the recording system, and the recording system includes a personal computer (PC) 6 where the DAW is operating. This PC (DAW) 6 is an embodiment of the audio signal processing device of the invention.

The mixer 1 includes plural input channels being an input signal series, buses mixing audio signals from the input channels, and output channels being an output signal series outputting audio signals produced by the mixing. Each input channel controls frequency characteristics, mixing levels, and so on of an input audio signal and outputs the controlled audio signal to each mixing bus, and each mixing bus performs mixing of the input audio signal and outputs the mixed audio signal to a corresponding output channel. The PC (DAW) 6 according to the invention is able to assign and record the audio signal of each input channel outputted from the mixer 1 to each track of a project having plural tracks. As to the audio signals outputted from the mixer 1 to the PC (DAW) 6 at a recording time, there are a direct-out signal which is an audio signal at a predetermined position before a fader of the input channel directly outputted via an output port, and a post fader signal which is an audio signal just after the fader adjusting a level of the input channel. Which audio signal is outputted from the mixer 1 can be set at the mixer 1.

Besides, a configuration of another audio signal processing system made up by connecting the audio signal processing device of an embodiment of the invention to an audio network is illustrated in FIG. 2.

The audio signal processing system illustrated in FIG. 2 includes an audio network 7 such as Ethernet (trademark), and the audio signal processing system is made up by connecting an AD/DA device 1a, a signal processing device (DSP device) 1b, a console 1c, and a PC (DAW) 6 to the audio network 7. The PC (DAW) 6 is an embodiment of the audio signal processing device of the invention. The AD/DA part 1a includes a physical input port being an input terminal to which a microphone, a synthesizer, and so on are connected, a physical output port being an output terminal to which an amplifier and so on are connected, and a communication I/O terminal which is connected to the audio network 7. Further, an AD converter converting plural analog signals inputted to an analog input port into digital signals and outputting the converted signals, and a DA converter converting plural digital output signals supplied to an analog output port into analog output signals and outputting the converted signals are included. Besides, the DSP device 1b includes a number of DSPs (Digital Signal Processors), and a communication I/O terminal which is connected to the audio network 7, and performs a mixing process, an effect process, and so on.

The console 1c is provided with plural moving faders for adjusting a send-out level of an input channel to a mixing bus, a number of controls for operating various kinds of parameters, and a communication I/O terminal which is connected to the audio network 7 on a console panel thereof. An operator operating the console 1c adjusts volumes and tones of each audio signal of performance sounds and vocal sounds such that the performance is expressed in a most suitable state by operating the moving fader and the various kinds of controls. The DAW software is installed into the PC (DAW) 6, and the PC (DAW) 6 is an audio signal processing device of an embodiment of the invention in which a DAW is operating. The PC (DAW) 6 includes a communication I/O terminal which is connected to the audio network 7, and functions of recording and reproducing of the audio signals, or audio signal processing functions such as an effect addition, mixing, and so on are realized by the DAW software.

The AD/DA device 1a, the DSP device 1b, and the console 1c are logically connected by the audio network 7, and thereby, a mixer equivalent to the mixer 1 illustrated in FIG. 1 is actualized. It is possible to perform recording of the actualized mixer by the DAW operating at the PC (DAW) 6. The PC (DAW) 6 is logically connected to the mixer via the audio network 7, and therefore when the recording is performed, the DAW can be logically connected to an arbitrary position of the mixer including the AD/DA device 1a, the DSP device 1b, and the console 1c, thereby enabling to take out a signal at the arbitrary position. Namely, in the above-stated another audio signal processing system, it is possible to record, in the DAW, a direct-out signal, a post fader signal, and so on of the input channel according to setting on the PC (DAW) 6 side.

The DAW operating in the PC (DAW) 6 creates a new project when the DAW records audio signals outputted from each channel of the mixer in the audio signal processing system illustrated in FIG. 1 or FIG. 2. The DAW creates the same number of tracks as the number of channels of the mixer in the new project, and names each track after name of each channel. Further, the DAW assigns each channel to each track by bringing channel number and channel name of each channel into correspondence with track number and track name of each track, and records audio signal of each channel in the track corresponding to the channel. In this case, the DAW operating at the PC (DAW) 6 being the audio signal processing device of the invention obtains at least channel configuration information including number of channels and names of channels from the mixer side, automatically creates the same number of tracks as the obtained number of channels, and automatically name the respective created tracks after the respective obtained channel names, when the DAW creates a new project. It is thereby possible for a user to easily perform settings for recording on the DAW of the PC (DAW) 6 without setting operation while verifying number of channels and names channels of the mixer.

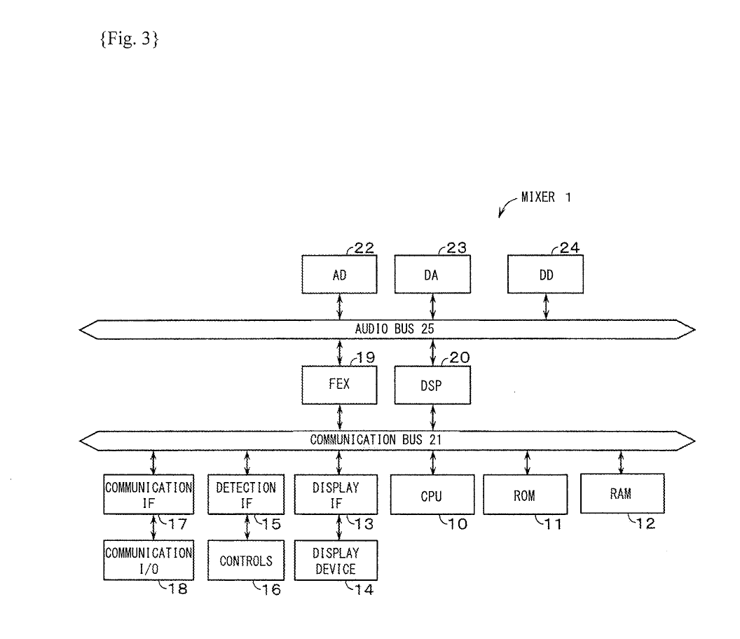

Here, a block diagram illustrating a hardware configuration of the mixer 1 illustrated in FIG. 1 is illustrated in FIG. 3. Note that a hardware configuration of the mixer actualized in the another audio signal processing system illustrated in FIG. 2 is equivalent to the hardware configuration illustrated in FIG. 3.

In the mixer 1 illustrated in FIG. 3, a CPU (Central Processing Unit) 10 executes a management program (OS: Operating System), and all operations of the mixer 1 are controlled on the OS. The mixer 1 includes a non-volatile ROM (Read Only Memory) 11 where operation software such as a control program executed by the CPU 10 is stored, and a RAM (Random Access Memory) 12 where work areas of the CPU 10 are provided and various kinds of data and so on are stored. The CPU 10 executes the control program to thereby perform an audio signal processing on plural input audio signals by a DSP 20 to perform a mixing process. Note that it is possible to enable rewrite of the operation software by using a rewritable ROM such as a flash memory as the ROM 11. Version upgrade of the operation software can be easily performed by using the rewritable ROM. The DSP 20 performs audio signal processing based on set values of parameters such that the DSP 20 adjusts volume level, frequency characteristics, and so on of the input audio signals, mixes the adjusted audio signals, and further adjusting volume level, pan, effect, and so on of the mixed audio signals. An effector (EFX) 19 adds effects such as reverb, echo, and chorus to the mixed audio signals under control of the CPU 10.

A display IF 13 is a display interface displaying various screens relating to the audio signal processing on a display device 14 such as a liquid crystal display device. A detection IF 15 scans controls 16 such as faders, knobs, and switches provided on a panel of a console of the mixer 1 to detect operations on the controls 16. The CPU 10 edits values of parameters used for the audio signal processing based on operation signals detected by the detection IF 15. A communication IF 17 is a communication interface to communicate with an external equipment via a communication I/O 18, and it is an interface for communication via networks such as Ethernet (trademark). The CPU 10, the ROM 11, the RAM 12, the display IF 13, the detection IF 15, the communication IF 17, the EFX 19, and the DSP 20 send and receive data and so on with each other via a communication bus 21.

The EFX 19 and the DSP 20 send and receive data and so on to/from an AD 22, a DA 23, a DD 24 making up an input output device via an audio bus 25. The AD 22 includes one or more physical input ports being input terminals where analog audio signals are inputted. The AD 22 converts an analog audio signal inputted to the input port of the AD 22 into a digital audio signal, and sends the converted digital audio signal out to the audio bus 25. The DA 23 includes one or more physical output ports being output terminals for outputting a mixed signal produced by mixing in the DSP 20 toward outside. The DA 23 converts a digital audio signal received via the audio bus 25 into an analog audio signal, and outputs the converted analog audio signal from the output port of the DA 23. The analog audio signal is outputted from speakers connected to the output port and disposed at a hall or a stage. The DD 24 includes one or more physical input ports being input terminals where digital audio signals are inputted and one or more physical output ports being output terminals outputting a digital audio signal produced by mixing in the DSP 20 toward outside. The DD 24 sends a digital audio signal inputted to the input port of the DD 24 to the audio bus 25, and outputs a digital audio signal received via the audio bus 25 from the output port. The outputted digital audio signal is supplied to a recording system and so on connected to the output port. The digital audio signals sent out from the AD 22 and the DD 24 to the audio bus 25 are received by the DSP 20, and the DSP 20 performs the above-stated digital signal processing on the digital audio signals. Besides, the digital audio signal produced by the mixing and sent out from the DSP 20 to the audio bus 25 is received by the DA 23 or the DD 24.

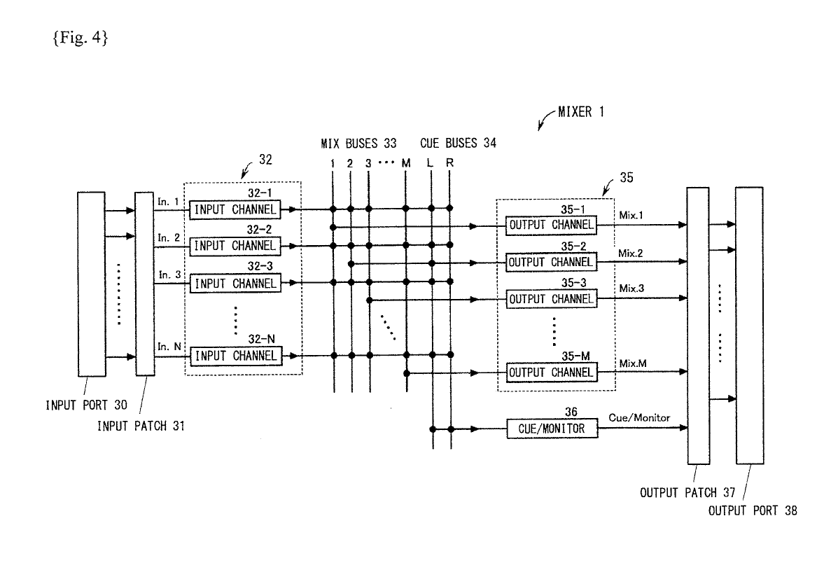

Next, a functional block diagram equivalently illustrating a process algorithm of the mixer 1 is illustrated in FIG. 4.

In FIG. 4, digital audio signals supplied via plural input ports 30 are inputted to an input patch 31. These input ports 30 are the physical input terminals provided in the AD 22 and the DD 24. The input patch 31 selectively patches each of the plural physical input ports being input sources of the audio signals to each of logical input channels 32-1, 32-2, 32-3, . . . , 32-N provided in an input channel section 32 having N input channels (where N is an integer of one or more: for example, 96). In this case, the input port can be patched to the plural input channels, but only one input port can be patched to the input channel. The respective input channels 32-1 to 32-N are supplied with audio signals In.1, In.2, In.3, In.N from the corresponding input port patched with the input channel by the input patch 31. The input channels 32-1 to 32-N respectively adjust audio characteristics and so on of the audio signals In.1, In.2, In.3, In.N inputted to the respective input channels. Namely, each of the input channels 32-1 to 32-N adjusts characteristics of the audio signal by an equalizer, a compressor, and the like, and further adjusts send level of the audio signal, and sends out the adjusted audio signal to each of M (M is an integer of one or more) pieces of mixing buses 33 and L, R stereo cue buses 34. In this case, each of the input channels 32-1 to 32-N output the adjusted audio signals to one or plural pieces of buses selected for that input channel among the M pieces of mixing buses 33.

The mixing buses 33 mix, at each of the M pieces of buses, audio signals sent out from one or plural arbitrary input channels among the N input channels, and output total M pieces of mixed audio signals. The mixed audio signals from the respective buses of the M pieces of mixing buses 33 are respectively outputted to output channels 35-1, 35-2, 35-3, . . . , 35-M of an output channel section 35 having M output channels. The respective output channels 35-1 to 35-N adjust characteristics such as frequency balance of the audio signal supplied from the corresponding mixing buses by equalizers, compressors, and the like, and output the adjusted audio signals to an output patch 37 as output channel signals Mix.1, Mix.2, Mix.3, Mix.M. Besides, the L, R cue buses 34 respectively mixes one or plural input channel signals inputted from the N input channel and output the mixed audio signals to a cue/monitor section 36 audio signals for cue/monitor. The cue/monitor section 36 adjusts characteristics of the audio signals such as frequency balance by equalizers and compressors and outputs the adjusted audio signals to the output patch 37 as cue/monitor outputs.

The output patch 37 selectively patches any of the M output channel signals Mix.1 to Mix.M from the output channel section 35 and the cue/monitor outputs from the cue/monitor section 36 to any of plural output ports 38. The respective output ports 38 are supplied with audio signals from the output channel (or the cue/monitor section 36) patched with the output port by the output patch 37. Each output port 38 provided with an analog output terminal converts the supplied digital audio signal into an analog audio signal, and outputs the converted audio signal as an analog output signal. The analog output signal is amplified by an amplifier connected to the output port 38 to be emitted from plural speakers disposed at a hall or the like. Further, the analog output signal from the output port 38 is supplied to an in-ear monitor worn in the ear by a musician or the like on the stage, or it is reproduced on a stage monitor speaker placed in a vicinity of the in-ear monitor. Besides, the digital audio signal outputted from each output port 38 provided with a digital output terminal outputs the digital audio signal supplied from the output channel patched by the output patch 37 as a digital output signal. The digital output signal is supplied to a recording system, a DAT, and so on connected to the output port 38, and the digital output signal can be recorded by digital recording. Besides, the cue/monitor outputs are converted into an analog audio signal at the output ports 38 patched with the cue/monitor section 36 by the output patch 37, and outputted via the output ports 38 to a monitor speaker disposed at an operator room, a headphone worn by an operator, and so on, and the operator can check the signals. As stated above, the output patch 37 selectively patches the output channels being logical channels to the output ports being physical output terminals.

Note that predetermined positions of the input channels 32-1 to 32-N is patched to the output ports 38 by the output patch 37, and thereby, direct-out is realized through it is not illustrated.

All of the input channels 32-1 to 32-N in the input channel section 32 illustrated in FIG. 4 have the same configuration. Therefore, the input channel 32-i is exemplified to illustrate configuration of the input channel in FIG. 5A.

One of the input ports is patched to the input channel 32-i illustrated in FIG. 5A by the input patch 31. The input channel 32-i includes an attenuator (Att) 41, a head amplifier (H/A) 42, a high-pass filter (HPF) 43, an equalizer (EQ) 44, a noise gate (Gate) 45, a compressor (Comp) 46, a delay (Delay) 47, a fader (Level) 48, a pan (Pan) 49 connected one another in cascade. The attenuator 41 adjusts an attenuation amount of an input digital audio signal, and the head amplifier 42 is an amplifier amplifying the input digital audio signal. The high-pass filter 43 is a filter cutting a band of the input digital audio signal of which frequency is lower than a specific frequency. The equalizer 44 is an equalizer adjusting frequency characteristics of the input digital audio signal, and for example, adjusts frequency characteristics of four bands of HI, MID HI, LOW MID, and LOW, respectively.

The noise gate 45 is a noise gate blocking noises, and blocks the noises by rapidly lowering a gain of the input digital audio signal when a level of the input digital audio signal becomes a reference value or less. The compressor 46 prevents saturation of the input digital audio signal by narrowing a dynamic range of the input digital audio signal. The delay 47 performs a time delay of the input digital audio signal so as to perform a distance correction between a sound source and a microphone connected to the patched input port. The fader 48 is a level control unit controlling a send-out level from the input channel 32-i to the mixing buses 33. The send-out level can be operated by the controls such as moving faders. The pan 49 adjusts right and left balance (position of sound image) of the signal transmitted from the input channel 32-i to a pair of mixing buses 33 set to be stereo.

The digital audio signal outputted from the input channel 32-i can be supplied to arbitrary plural mixing buses 33 and also to the cue buses 34.

Note that position of the direct-out output from the mixer to the PC (DAW) 6 can be selected from among just before the attenuator 41, just before the HPF 43, just before the fader 48, and so on.

Besides, all of the output channels 35-1 to 35-M at the output channel section 35 illustrated in FIG. 4 have the same configuration. Therefore, the output channel 35-j is exemplified to illustrate the configuration of the output channel in FIG. 5B.

A mixed output digital audio signal from the j-th bus of the mixing buses 33 is inputted to the output channel 35-j illustrated in FIG. 5B. The output ch 35-j includes an equalizer (EQ) 51, a compressor (Comp) 52, a fader (Level) 53, a balance (Bal) 54, a delay (Delay) 55, and an attenuator (Att) 56 connected one another in cascade. The equalizer 51 is an equalizer adjusting frequency characteristics of the digital audio signal, and for example, adjusts frequency characteristics of six bands of HI, MID HI, MID, LOW MID, LOW, and SUB MID, respectively. The compressor 52 prevents saturation of the digital audio signal by narrowing a dynamic range of the digital audio signal. The fader 53 is a level control unit controlling an output level from the output channel 35-j to the output patch 37. The output level can be operated by the controls such as moving faders. The balance 54 adjusts a right and left volume balance when the output channel 35-j is set to be a stereo. The delay 55 performs a time delay of the digital audio signal to be outputted so as to perform correction of distance, sound image position, and so on, of speakers. The attenuator 56 adjusts an attenuation amount of the digital audio signal to be outputted to the output patch 37.

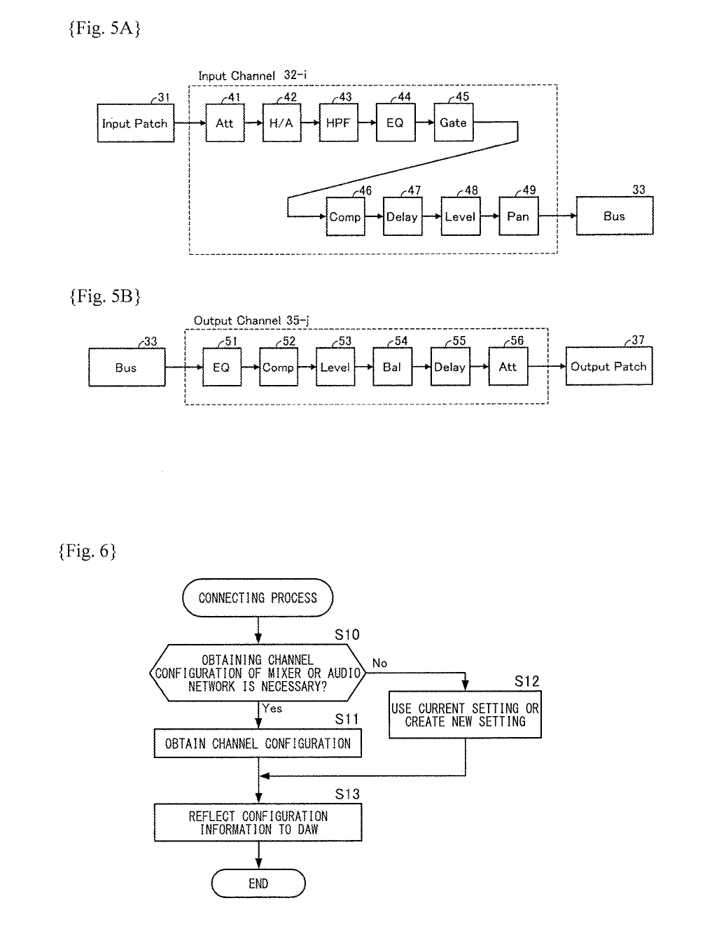

When the PC (DAW) 6 being an audio signal processing device of an example of the invention is connected to the mixer 1 or power of the mixer 1 connected to the PC (DAW) is turned on, a connecting process illustrated in a flowchart in FIG. 6 is started. Besides, the connecting process illustrated in FIG. 6 is also started when the PC (DAW) 6 is connected to the audio network 7 illustrated in FIG. 2 or the power of the PC (DAW) 6 is turned on.

When the connecting process is started at the PC (DAW) 6, the PC (DAW) 6 displays on a display thereof a window for receiving instruction regarding whether or not it is necessary to obtain the channel configuration information of the mixer 1 or the mixer constructed by the audio network 7 in step S10. Here, when a user clicks a button for instructing to obtain the channel configuration in the window by a pointing device and so on, the PC (DAW) 6 judges that the PC (DAW) 6 should obtain the channel configuration information, and a process goes to step S11. At step S11, the PC (DAW) 6 obtains the channel configuration information from the mixer 1 by transmitting a command requiring the channel configuration information to the mixer 1, or obtains the channel configuration information from a device, for example, the console 1c, having the channel configuration information of the mixer constructed by the audio network 7 by transmitting a command requiring the channel configuration information to the device. The channel configuration information includes at least information on number of channels in the mixer and names of the channels.

After obtaining the channel configuration information in step S11, the PC (DAW) 6 reflects the obtained channel configuration information on a project newly created in the PC (DAW) 6 at a time of recording in step S13. By this reflection, number of tracks in a newly created project becomes the same number as the number of channels indicated in the obtained channel configuration information, and the names of channels indicated in the obtained channel configuration information are sequentially applied to the respective tracks in the newly created project as names of tracks.

Besides, when the user clicks a button for instructing not to obtain the channel configuration by the pointing device and so on in step S10, the PC (DAW) 6 judges that it is not necessary to obtain the channel configuration, and the process branches to step S12. At step S12, the PC (DAW) 6 uses a current setting or creates a new setting according to the user's instruction. Then the PC (DAW) 6 reflects the configuration information set at the step S12 on a project newly created by the PC (DAW) 6 in step S13. In this case, number of channels and names of the channels in a newly created project becomes those according to the current setting or the setting created according to the user's instruction.

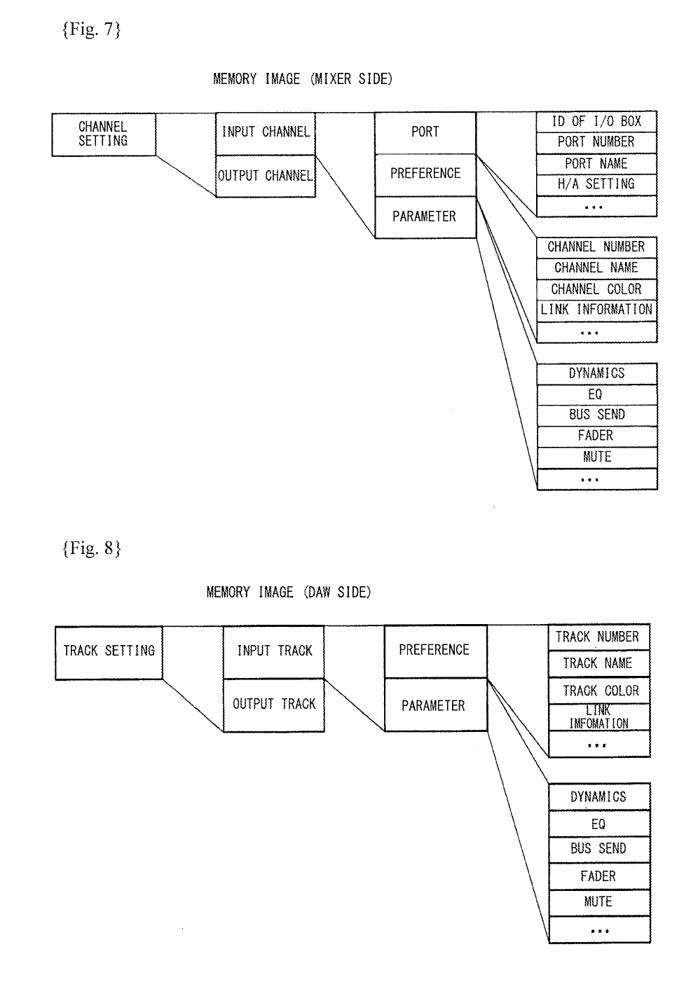

Next, a memory image of the channel configuration information of the mixer 1 or the mixer constructed by the audio network 7 is illustrated in FIG. 7.

As illustrated in FIG. 7, the channel configuration information (Channel Setting) of the mixer includes channel configuration information regarding the input channel side and channel configuration information regarding the output channel side. In FIG. 7, only the channel configuration information regarding the input channel side is illustrated, but the channel configuration information regarding the output channel side is in a similar configuration. The channel configuration information regarding the input channel side includes port information, preference information and parameter information. The port information indicates configuration of the input ports 30, and includes information such as ID (identification information) of an I/O box having physical input terminals, port number, port name information, and setting information of head amplifiers (H/A setting). Besides, the preference information includes channel number information indicating number of the input channels, channel name information indicating name of the each input channel, channel color information indicating a display color when the each input channel is displayed, link information of a stereo pair, and so on. Further, the parameter information includes a dynamics parameters used in dynamics series of the compressor (Comp) 46 and so on, an EQ parameters used in the equalizer (EQ) 44, BUS Send parameters indicating send-out levels to the mixing buses (Mix Bus) 33 and L, R stereo cue buses (Cue Bus) 34, fader parameters used in the fader (Level) 48, mute parameters indicating mute on/off, and so on.

On the other hand, a memory image of the track configuration information of the DAW operating in the PC (DAW) 6 is illustrated in FIG. 8.

As illustrated in FIG. 8, the track configuration information (track setting) of the DAW includes track configuration information regarding the input track side and track configuration information regarding the output track side. In FIG. 8, only the track configuration information regarding the input track side is illustrated, but the track configuration information regarding the output track side is in a similar configuration. The track configuration information regarding the input track side includes preference information and parameter information. The preference information includes track number information indicating number of tracks, track name information indicating names of the each track, track color information indicating a display color when the each track is displayed, link information of a stereo pair, and so on. Further, the parameter information includes a dynamics parameters used in dynamics series, EQ parameters used in the equalizer, BUS Send parameters indicating send-out levels to the mixing buses, fader parameters used in the fader, mute parameters indicating mute on/off, and so on.

The channel configuration information obtained in step S11 in the connecting process is at least the preference information of the mixer illustrated in FIG. 7, and the obtained preference information is reflected on the preference information of the project newly created in the DAW. Namely, the channel number information and the channel name information are reflected on the track number information and the track name information, and thereby names same as the names of the channels are sequentially given to the respective tracks created to be the same number as the number of channels. Further, the channel color information is reflected on the track color information, and thereby display colors of the tracks become the same color as the display color of the corresponding channels, that is, colors of the tracks aligns in the same order as those of the channels. Besides, the link information of the channels is reflected on the link information of the tracks, and the tracks become the same stereo pairs as the stereo pairs of the channels.

According to the invention described hereinabove, the PC (DAW) 6 transmits a command for obtaining channel configuration information of at least number of channels and names of the channels to the mixer side when the PC (DAW) 6 creates a new project at a time of recording or the like. The mixer side transmits the channel configuration information to the DAW as a response to the command. However, the invention is not limited thereto. The mixer may transmit the channel configuration information of the mixer when the mixer is turned on. The PC where the DAW is operating receives the transmitted channel configuration information, and the DAW creates, at a time of recording or the like, a new project in which information such as number of channels and names of the channels in the channel configuration information received from the mixer is reflected on number of tracks and names of the tracks. The DAW records an audio signal in each track indicated in the newly created project such that the audio signal from each channel is recorded in a track having the same name as the name of the channel. Besides, it is also conceivable that the mixer transmits the channel configuration information of the mixer to the PC (DAW) 6 when the mixer is started. Also in this case, the DAW operating in the PC (DAW) 6 can create, at a time of recording or the like, a new project in which information such as number of channels and names of the channels in the channel configuration information received from the mixer is reflected on number of tracks and names of the tracks, and record an audio signal in each track indicated in the newly created project.

### REFERENCE SIGNS LIST

1 . . . mixer, 1a . . . AD/DA device, 1b . . . DSP device, 1c . . . console, 2 . . . synthesizer, 3a to 3h . . . microphones, 4 . . . amplifier, 5a to 5k . . . speaker, 6 . . . PC (DAW), 7 . . . audio network, 10 . . . CPU, 11 . . . ROM, 12 . . . RAM, 13 . . . display IF, 14 . . . display device, 15 . . . detection IF, 16 . . . controls, 17 . . . communication IF, 18 . . . communication I/O, 19 . . . EFX, 20 . . . DSP, 21 . . . communication bus, 22 . . . AD, 23 . . . DA, 24 . . . DD, 25 . . . audio bus, 30 . . . input ports, 31 . . . input patch, 32 . . . input channel section, 32-1 to 32-i to 32-N . . . input channel, 33 . . . mixing buses, 34 . . . cue buses, 35 . . . output channel section, 35-1 to 35-M . . . output channel, 36 . . . cue/monitor section, 37 . . . output patch, 38 . . . output ports, 41 . . . attenuator, 42 . . . head amplifier, 43 . . . high pass filter, 44 . . . equalizer, 45 . . . noise gate, 46 . . . compressor, 47 . . . delay, 48 . . . fader, 49 . . . pan, 51 . . . equalizer, 52 . . . compressor, 53 . . . fader, 54 . . . balance, 55 . . . delay, 56 attenuator

1. An audio signal processing device comprising recording function to record audio signals of one or more channels outputted from a mixer,
wherein the audio signal processing device obtains channel configuration information from the mixer, reflects the obtained channel configuration information to track configuration information in a project newly created at a time of recording, and records the audio signals of the respective channels in same number of tracks as the channels, respectively, the tracks being created based on the track configuration information to which the channel configuration information is reflected.

2. An audio signal processing device according to claim 1, wherein the audio signal processing device reflects information of number of channels and names of the channels included in the channel configuration information to number of tracks and name of the tracks in the track configuration information, respectively, and the audio signal processing device creates the same number of the tracks as the channels and gives each of the created tracks the same name as each of the channels, based on the track configuration information.

3. A non-transitory machine-readable medium containing program instructions executable by a computer that functions as an audio signal processing device comprising recording function to record audio signals of one or more channels outputted from a mixer, and enabling the computer to execute:
a step of creating, at a time of recording, a project including track configuration information to which channel configuration information obtained from the mixer is reflected, the track configuration information indicating same number of tracks as the one or more channels; and
a step of recording the audio signals of the respective one or more channels in the same number of tracks.
